(19) United States
(12) Patent Application Publication
(10) Pub. No.: US 2020/0389596 A1
(43) Pub. Date: Dec. 10, 2020

(54) IMAGE SENSOR AND IMAGE PROCESSING SYSTEM INCLUDING THEREOF

(71) Applicant: SAMSUNG ELECTRONICS co., LTD., SUWON-SI (KR)

(72) Inventors: DA HEE LEE, SUWON-SI (KR); YONG SEONG KIM, SUWON-SI (KR); YOUNG Ml JO, HWASEONG-SI (KR); DONG KI MIN, SEOUL (KR); JOON HYUK IM, SEOUL (KR); IL YUN JEONG, YONGIN-SI (KR)

(21) Appl. No.: 16/794,896

(22) Filed: Feb. 19, 2020

(30) Foreign Application Priority Data
Jun. 4, 2019 (KR) 10-2019-0065663

(51) Int. Cl. H04N 5/232; H04N 5/376

(52) U.S. Cl. CPC H04N 5/23274; H04N 5/3765

(57) ABSTRACT

An image sensor includes a video acquiring circuit to convert light incident in a first direction through a lens into an electrical signal to acquire image data, a clock signal generating circuit to generate and output a clock signal on current time information, a stabilization data generating circuit to generate stabilization data, image time information on a time point at which the image data is acquired, and stabilization time information on a time point at which the stabilization data is generated, on the basis of the clock signal, and an output circuit. The stabilization data generating circuit generates first stabilization data on a position of the lens and first stabilization time information on a time point at which the first stabilization data is generated, and the output circuit outputs the image data, the image time information, the first stabilization data, and the first stabilization time information.

### CROSS-REFERENCE TO RELATED APPLICATION

This application claims priority under 35 U.S.C. § 119 to Korean Patent Application No. 10-2019-0065663, filed on Jun. 4, 2019 in the Korean Intellectual Property Office, the disclosure of which is incorporated by reference herein in its entirety.

### TECHNICAL FIELD

Exemplary embodiments of the present inventive concept relate to an image sensor and an image processing system, and more specifically, to an image sensor and an image processing system which perform an electronic image stabilization (EIS) processing operation in consideration of a processing result of optical image stabilization (OIS).

### DISCUSSION OF RELATED ART

A camera module including an image sensor may be mounted on devices such as mobile phones, drones, digital cameras, wearable cameras, or devices in the automotive field. When an image is acquired using the image sensor, if the camera module including the image sensor or the device including the camera module moves, deterioration of the acquired image occurs. In particular, when the camera module is mounted on a device with much motion, deterioration of the acquired image due to shaking gets worse. Therefore, it may be necessary to execute a process of correcting the image acquired by the image sensor to compensate for the motion of the camera module or the device.

For example, an optical image stabilization (OIS) or an electronic image stabilization (EIS) may be performed. OIS senses the motion and shaking through a gyro sensor and physically adjusts a position of the lens to change a path of the optical signal. EIS performs correction according to motion on an image to be output from the image sensor, e.g., an image converted into an electrical signal.

However, since the result of OIS that changes the physical position of the lens is not reflected in the EIS processing operation, artifacts may occur due to duplicated correction.

### SUMMARY

According to an exemplary embodiment of the present inventive concept, an image sensor includes a video acquiring circuit configured to convert light incident in a first direction through a lens into an electrical signal to acquire image data, a clock signal generating circuit configured to generate and output a clock signal on current time information, a stabilization data generating circuit configured to generate stabilization data for processing the image data, image time information on a time point at which the image data is acquired, and stabilization time information on a time point at which the stabilization data is generated, on the basis of the clock signal, and an output circuit configured to output data received from the video acquiring circuit and the stabilization data generating circuit. The stabilization data generating circuit generates first stabilization data on a position of the lens and first stabilization time information on a time point at which the first stabilization data is generated, and the output circuit outputs the image data, the image time information, the first stabilization data, and the first stabilization time information.

According to an exemplary embodiment of the present inventive concept, an image sensor includes a video acquiring circuit including a plurality of pixels arranged in a matrix form, and configured to acquire image data obtained by converting light incident through a lens into an electrical signal using a target pixel group of at least some of the plurality of pixels, where the video acquiring circuit exposes pixels of a first row of the target pixel group in a first section, performs a read operation of the pixels of the first row in a second section, exposes pixels of a last row of the target pixel group in a third section, and performs a read operation on the pixels of the last row in a fourth section, a clock signal generating circuit configured to generate and output a clock signal on current time information, a stabilization data generating circuit configured to generate first stabilization data on positions of the lens in the first and third sections, and generate image time information on a time at which the image data is acquired and first stabilization time information on a time at which the first stabilization data is generated, on the basis of the clock signal, and an output circuit configured to output data received from the video acquiring circuit and the stabilization data generating circuit.

According to an exemplary embodiment of the present inventive concept, an image processing system includes an image sensor configured to generate image data acquired by converting light incident through a lens into an electrical signal, image time information on a time at which the image data is acquired, stabilization data on a position of the lens, and stabilization time information on a time at which the stabilization data is generated, an image data processing circuit configured to perform an electronic image stabilization (EIS) processing operation on the basis of the image data, the image time information, the stabilization data, and the stabilization time information, and output image processing data generated on the basis of the EIS processing operation, and a display circuit configured to receive the image processing data and display an image on the basis of the image processing data.

### BRIEF DESCRIPTION OF THE DRAWINGS

The above and other aspects and features of the present inventive concept will become more apparent by describing in detail exemplary embodiments thereof with reference to the attached drawings.

FIG. 1 is a block diagram for explaining an image processing system according to an exemplary embodiment of the present inventive concept.

FIGS. 2 and 3 are block diagrams for explaining an image sensor of FIG. 1 according to an exemplary embodiment of the present inventive concept.

FIG. 4 is a block diagram for explaining a stabilization data generating unit according to an exemplary embodiment of the present inventive concept.

FIG. 5 is a diagram for explaining image data acquired by a video acquiring unit and stabilization data generated by the stabilization data generating unit of FIG. 4 according to an exemplary embodiment of the present inventive concept.

FIG. 6 is a diagram for explaining image sensor output data including the image data acquired by the video acquiring unit, and an image time signal, stabilization data, and a stabilization time signal generated by the stabilization data generating unit of FIG. 4 according to an exemplary embodiment of the present inventive concept.

FIG. 7 is a block diagram for explaining the stabilization data generating unit of FIG. 4 according to an exemplary embodiment of the present inventive concept.

FIG. 8 is a diagram for explaining the image data acquired by the video acquiring unit and the stabilization data generated by the stabilization data generating unit of FIG. 7 according to an exemplary embodiment of the present inventive concept.

FIG. 9 is a diagram for explaining image sensor output data including the image data acquired by the video acquiring unit, and an image time signal, stabilization data, and a stabilization time signal generated by the stabilization data generating unit of FIG. 7 according to an exemplary embodiment of the present inventive concept.

FIG. 10 is a block diagram for explaining a stabilization data generating unit according to an exemplary embodiment of the present inventive concept.

FIG. 11 is a diagram for explaining the image data acquired by the video acquiring unit and the stabilization data generated by the stabilization data generating unit of FIG. 10 according to an exemplary embodiment of the present inventive concept.

FIG. 12 is a diagram for explaining image sensor output data including the image data acquired by the video acquiring unit, and an image time signal, stabilization data, and a stabilization time signal generated by the stabilization data generating unit of FIG. 10 according to an exemplary embodiment of the present inventive concept.

FIG. 13 is a diagram for explaining time information generated in the process of acquiring image data according to an exemplary embodiment of the present inventive concept.

FIG. 14 is a block diagram for explaining an image data processing unit according to an exemplary embodiment of the present inventive concept.

FIGS. 15 to 17 are flowcharts for explaining an operation of an image sensor according to exemplary embodiments of the present inventive concept.

FIG. 18 is a flowchart for explaining an operation of an image processing system according to an exemplary embodiment of the present inventive concept.

### DETAILED DESCRIPTION OF THE EMBODIMENTS

Exemplary embodiments of the present inventive concept provide an image sensor which reads out a pixel array having a pixel structure including a plurality of photoelectric conversion elements sharing a floating diffusion area with one another.

Exemplary embodiments of the present inventive concept will be described more fully hereinafter with reference to the accompanying drawings. Like reference numerals may refer to like elements throughout this application.

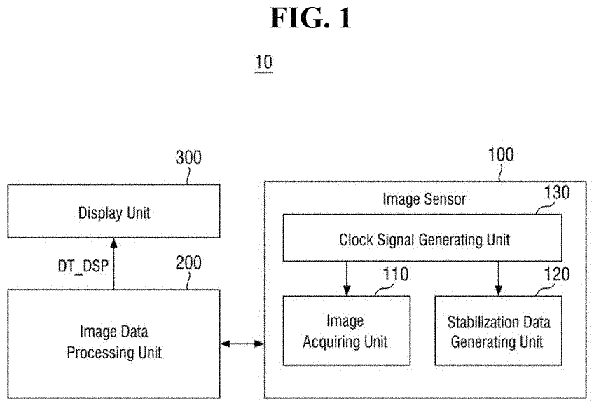

Hereinafter, an image sensor and an image processing system according to exemplary embodiments of the present inventive concept will be described with reference to FIGS. 1 to 18.

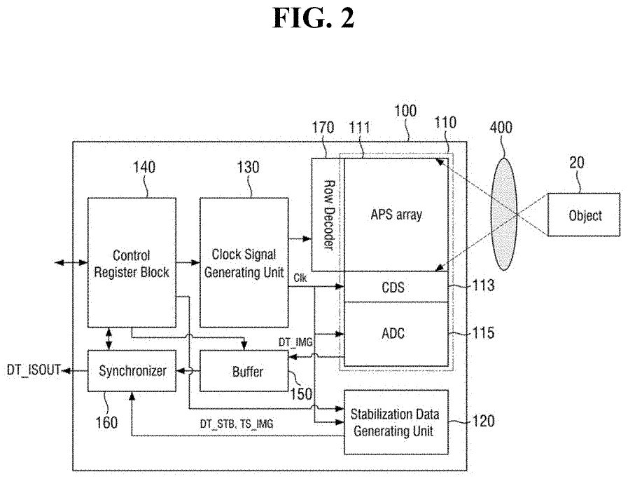

FIG. 1 is a block diagram for explaining an image processing system according to an exemplary embodiment of the present inventive concept. FIGS. 2 and 3 are block diagrams for explaining an image sensor of FIG. 1 according to an exemplary embodiment of the present inventive concept.

Referring to FIGS. 1 and 2, an image processing system 10 according to an exemplary embodiment of the present inventive concept may include an image sensor 100, an image data processing unit 200, a display unit 300, and a lens 400. Elements of the image processing system 10 may be implemented in hardware, e.g., as circuits.

The image sensor 100 may sense an object 20 imaged through the lens 400 under the control of the image data processing unit 200. The image sensor 100 may include a video (or image) acquiring unit 110, a stabilization data generating unit 120, a clock signal generating unit 130, a control register block 140, a buffer 150, a synchronizer 160, and a row decoder 170.

The video acquiring unit 110 may convert light, which is incident through the lens 400, into an electrical signal to acquire image data DT_IMG on the object 20. According to an exemplary embodiment of the present inventive concept, the video acquiring unit 110 may include a pixel array 111, a correlated double sampling block (CDS) 113, and an analog digital converter (ADC) 115.

The pixel array 111 may include a plurality of optical detection elements, such as photodiodes and pinned photodiodes. The pixel array 111 may detect light using the plurality of optical detection elements and may convert light into an electrical signal to generate an image signal. According to an exemplary embodiment of the present inventive concept, the pixel array 111 may have a plurality of pixels arranged in a matrix form. Each of the plurality of pixels is a red pixel for converting light of a red spectral region into an electrical signal, a green pixel for converting light of a green spectral region into an electrical signal, and a blue pixel for converting light of a blue spectral region into an electrical signal. Additionally, respective color filter arrays for transmitting light of a specific spectral region may be arranged on the top of each of the plurality of pixels constituting the pixel array 111.

The row decoder 170 may drive the pixel array 111 row by row. For example, the row decoder 170 may generate a row selection signal. According to an exemplary embodiment of the present inventive concept, the pixel array 111 outputs a reset signal and a video signal from a row selected by the row selection signal, which is provided from the row decoder 170, to the correlated double sampling block 113, and the correlated double sampling block 113 may perform correlated double sampling on the reset signal and the video signal to generate a correlated double sampled signal.

The analog digital converter 115 compares a lamp signal generated on the basis of a clock generated by the clock signal generating unit 130 with the correlated double sampled signal, counts a comparison result signal, and may output the image data DT_IMG to the buffer 150.

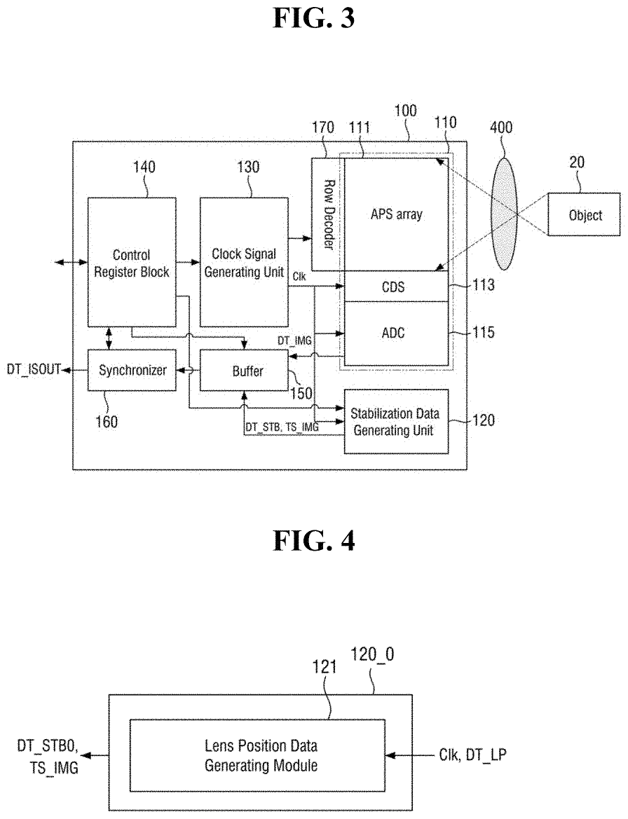

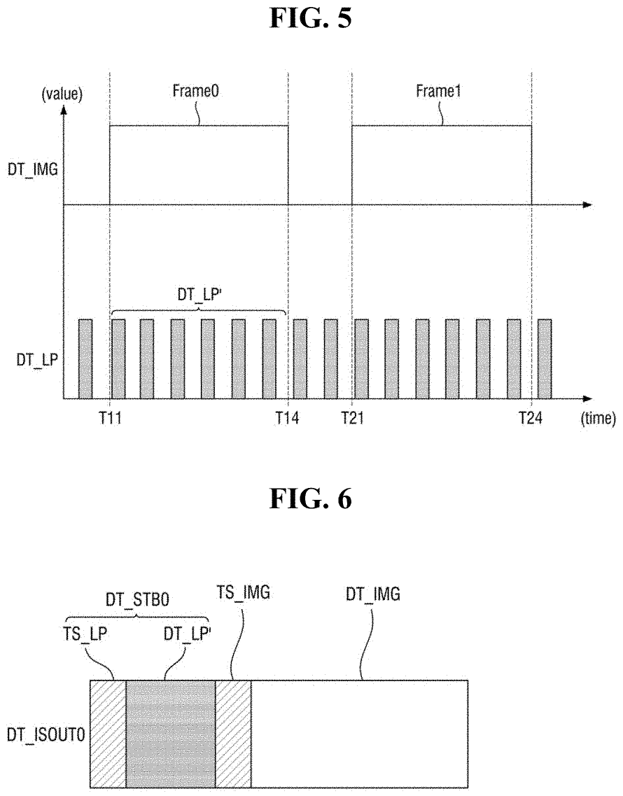

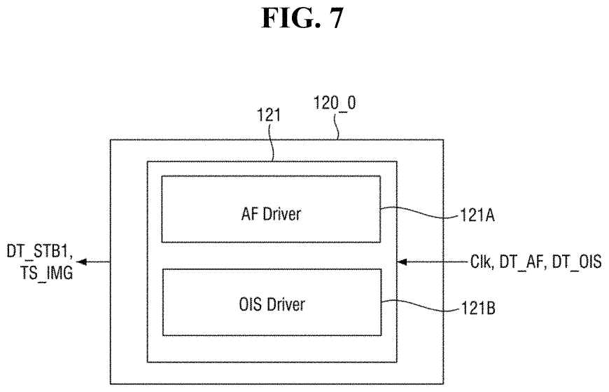

The stabilization data generating unit 120 may generate image time information TS_IMG and a stabilization data group DT_STB used for stabilization processing of the image data DT_IMG that is output from the video acquiring unit 110. According to an exemplary embodiment of the present inventive concept, the stabilization data generating unit 120 may receive stabilization data (e.g., DT_LP of FIG. 4), and extract and output the stabilization data (e.g., DT_LP′ of FIG. 5) for the stabilization processing operation of the image data DT_IMG. Further, the stabilization data generating unit 120 generates the image time information TS_IMG at the time at which the image data DT_IMG is acquired, and stabilization time information (e.g., TS_LP of FIG. 6) at the time at which the extracted stabilization data DT_LP′ is generated, on the basis of a clock signal Clk that is output from the clock signal generating unit 130, and may output the stabilization data group DT_STB and the image time signal TS_IMG including the extracted stabilization data DT LP′ and the stabilization time information TS LP to the synchronizer 160.

According to an exemplary embodiment of the present inventive concept, the stabilization data generating unit 120 may include an internal buffer, may temporarily store the extracted stabilization data DT_LP′, the generated image time information TS_IMG, and the stabilization time information TS_LP in the internal buffer and then output them to the synchronizer 160.

The clock signal generating unit 130 may output the clock signal Clk to each of the row decoder 170, the correlated double sampling block 113, the analog digital converter 115, and the stabilization data generating unit 120 to control the above-described operation. According to an exemplary embodiment of the present inventive concept, the clock signal Clk that is output by the clock signal generating unit 130 may include information on the current time.

The control register block 140 may output control signals to each of the clock signal generating unit 130, the stabilization data generating unit 120, the buffer 150, and the synchronizer 160 to control the above-described operation. According to an exemplary embodiment of the present inventive concept, the control register block 140 may operate under the control of the image data processing unit 200.

The buffer 150 may buffer the image data DT_IMG that is output from the video acquiring unit 110. According to an exemplary embodiment of the present inventive concept, the buffer 150 may sense and amplify the image data DT_IMG and output it.

The synchronizer 160 receives the image data DT_IMG output from the buffer 150 and the image time signal TS_IMG and the stabilization data group DT_STB output from the stabilization data generating unit 120, and may synchronize the image data DT_IMG, the image time signal TS_IMG, and the stabilization data group DT_STB to output image sensor output data DT_ISOUT. Therefore, the image data DT_IMG, the image time information TS_IMG, the stabilization data DT_LP′, and the stabilization time information TS_LP may be output to the image data processing unit 200.

The image sensor 100 may further include an output unit. The output unit may include at least one port. According to an exemplary embodiment of the present inventive concept, the image sensor output data DT_ISOUT, e.g., the image data DT_IMG, the image time information TS_IMG, and the stabilization data group DT_STB may be output through the at least one port.

The image data processing unit 200 controls the image sensor 100, performs a stabilization processing operation on the image sensor output data DT_ISOUT sensed and output by the image sensor 100, and may output the image data DT_IMG.

According to an exemplary embodiment of the present inventive concept, the image data processing unit 200 may control the control register block 140 of the image sensor 100. Although the image data processing unit 200 may control the image sensor 100, e.g., the control register block 140, using an inter-integrated circuit (I2C), the present inventive concept is not limited thereto.

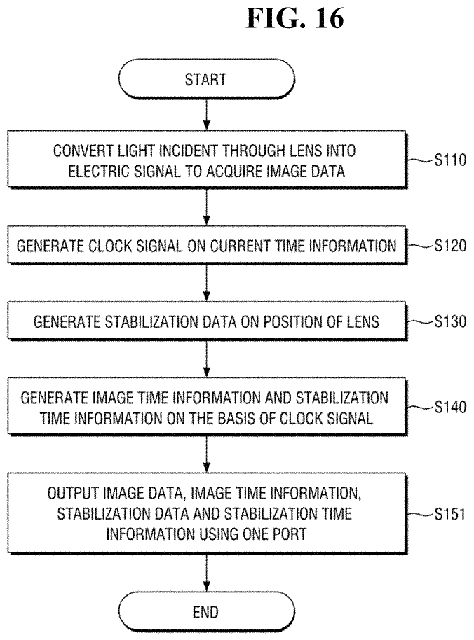

The image data processing unit 200 receives an input of image sensor output data DT_ISOUT which is an output signal of the image sensor 100, performs fabricating/processing operations such as a stabilization processing operation, and may output the corrected data DT_DSP of FIG. 14 to the display unit 300.

Although the image data processing unit 200 is shown as a configuration independent of the image sensor 100 in FIGS. 1 to 3, the present inventive concept is not limited thereto. In other words, the design of the image data processing unit 200 may be changed to be located inside the image sensor 100.

According to an exemplary embodiment of the present inventive concept, the image data processing unit 200 performs the stabilization processing operation of the image data DT_IMG, on the basis of the image sensor output data DT_ISOUT that is output from the image sensor 100. The stabilization processing operation of the image data DT_IMG and other post-processing operations are performed, and the corrected data DT_DSP of FIG. 14 is output to the display unit 300. The stabilization processing operation of the image data DT_IMG performed by the image data processing unit 200 will be described later with reference to FIG. 14.

The display unit 300 may output an image on the basis of the corrected data DT_DSP of FIG. 14. The display unit 300 may include all devices capable of outputting an image or a video. For example, the display unit 300 may include a computer, a smartphone, or other video output terminals.

Referring to FIG. 3, according to an exemplary embodiment of the present inventive concept, the buffer 150 may be implemented to receive the stabilization data group DT_STB and the image time signal TS_IMG from the stabilization data generating unit 120. In other words, the image time signal TS_IMG and the stabilization data group DT_STB which are the outputs of the stabilization data generating unit 120 are not directly transmitted to the synchronizer 160, and may be output to the synchronizer 160 after being temporarily stored in the buffer 150. In this case, after the buffer 150 receives the image data DT_IMG from the video acquiring unit 110, and receives the stabilization data group DT_STB and the image time signal TS_IMG from the stabilization data generating unit 120, the buffer 150 may output the received data to the synchronizer 160.

FIG. 4 is a block diagram for explaining a stabilization data generating unit according to an exemplary embodiment of the present inventive concept. FIG. 5 is a diagram for explaining image data acquired by a video acquiring unit, and stabilization data generated by the stabilization data generating unit of FIG. 4 according to an exemplary embodiment of the present inventive concept. FIG. 6 is a diagram for explaining image sensor output data including the image data acquired by the video acquiring unit, and an image time signal, stabilization data, and a stabilization time signal generated by the stabilization data generating unit of FIG. 4 according to an exemplary embodiment of the present inventive concept. An operation of a stabilization data generating unit 120_0 including a lens position data generating module 121 according to an exemplary embodiment of the present inventive concept will be described with reference to FIGS. 4 to 6.

Referring to FIG. 4, the stabilization data generating unit 120_0 according to an exemplary embodiment of the present inventive concept may include the lens position data generating module 121. According to an exemplary embodiment of the present inventive concept, the lens position data generating module 121 may receive the clock signal Clk and lens position data DT_LP (e.g., stabilization data). The lens position data generating module 121 generates the image time signal TS_IMG on the image data DT_IMG output from the video acquiring unit 110 on the basis of the clock signal Clk, extracts lens position data DT_LP′ (e.g., extracted stabilization data) for the stabilization processing operation of the image data DT_IMG from the lens position data DT_LP, and may generate the lens position time information TS_LP (e.g., stabilization time information) on the extracted lens position data DT_LP′.

According to an exemplary embodiment of the present inventive concept, the lens position data DT_LP may be data utilized to perform an AF (Auto Focusing) operation of the lens 400. In this case, the lens position data DT_LP may include information on the position of the lens 400 in an incident direction of light.

According to an exemplary embodiment of the present inventive concept, the lens position data DT_LP may be data used to perform an optical image stabilization (OIS) operation of the lens 400. In this case, the lens position data DT_LP may include information on the position of the lens 400 in a direction substantially perpendicular to the incident direction of light.

The stabilization data generating unit 120_0 may output generated stabilization data group DT_STB0 and the image time signal TS_IMG. The stabilization data group DT_STB0 may include the lens position data DT_LP′ and the lens position time information TS_LP.

Referring to FIG. 5, the stabilization data generating unit 120_0 may extract the lens position data DT_LP in a section in which target pixels included in the pixel array 111 are exposed to obtain the image data DT_IMG.

When a section from a first time point T11 to a fourth time point T14 is an exposure section of the pixel for acquisition of a first frame (Frame0), the stabilization data generating unit 120_0 extracts the data acquired in the section from the first time point T11 to the fourth time point T14 from the lens position data DT_LP and determines the extracted data as the lens position data DT_LP′.

Similarly, when a section from a seventh time point T21 to a tenth time point T24 is an exposure section of the pixel for acquisition of a second frame (Frame1), the stabilization data generating unit 120_0 may extract data acquired in a section from the seventh time point T21 to the tenth time point T24 from the lens position data DT_LP and may determine the extracted data as the lens position data DT_LP′.

Referring to FIG. 6, the image sensor 100 may output an image sensor output data DT_ISOUT0 including the stabilization data group DT_STB0, the image data DT_IMG, and the image time signal TS_IMG. According to an exemplary embodiment of the present inventive concept, the synchronizer 160 receives the image data DT_IMG from the buffer 150, receives the stabilization data group DT_STB0 and the image time signal TS_IMG from the stabilization data generating unit 120_0, and may synchronize the received data to output it to the image data processing unit 200. The stabilization data group DT_STB0 may include the lens position data DT_LP′ and the lens position time information TS_LP.

According to an exemplary embodiment of the present inventive concept, the buffer 150 may receive the image data DT_IMG from the video acquiring unit 110, and may receive the stabilization data group DT_STB0 and the image time signal TS_IMG from the stabilization data generating unit 120_0. The synchronizer 160 receives the image data DT_IMG, the image time signal TS_IMG, and the stabilization data group DT_STB0 from the buffer 150, and may synchronize the received data to output the image sensor output data DT_ISOUT. The stabilization data group DT_STB0 may include the lens position data DT_LP′ and the lens position time information TS_LP.

According to an exemplary embodiment of the present inventive concept, the image sensor 100 may output the image data DT_IMG, the image time signal TS_IMG, the lens position data DT_LP′, and the lens position time information TS_LP to the image data processing unit 200 through one port.

According to an exemplary embodiment of the present inventive concept, by generating the time information TS_IMG and TS_LP on the image data DT_IMG and the stabilization data DT_LP′, and by performing the stabilization processing operation of the image data DT_IMG using the same, the stabilization processing operation using the stabilization data that exactly matches the image data DT_IMG may be performed, and thus, the stability of the image data DT_IMG may be performed more correctly. In addition, by performing an electronic image stabilization (EIS) operation in consideration of the position information of the lens 400, it is possible to prevent an occurrence of artifacts caused by duplicated correction with corrections such as AF processing and OIS processing.

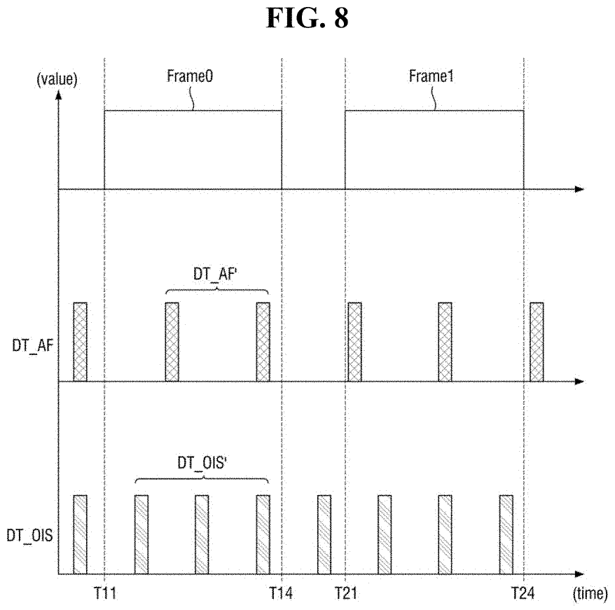

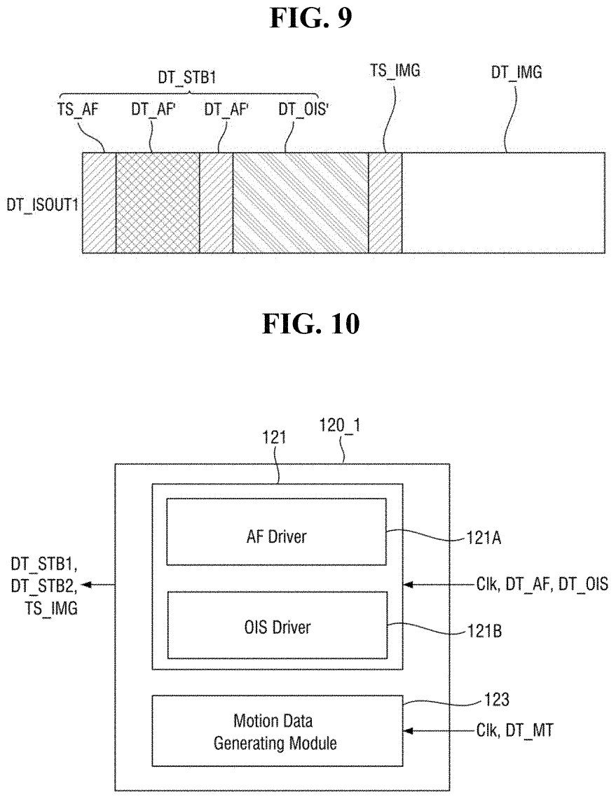

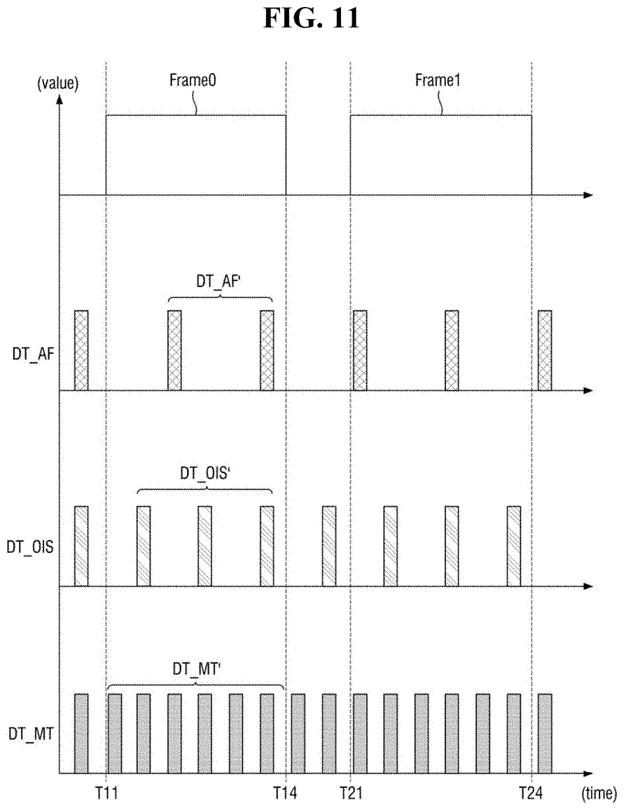

FIG. 7 is a block diagram for explaining the stabilization data generating unit of FIG. 4 according to an exemplary embodiment of the present inventive concept. FIG. 8 is a diagram for explaining the image data acquired by the video acquiring unit and the stabilization data generated by the stabilization data generating unit of FIG. 7 according to an exemplary embodiment of the present inventive concept. FIG. 9 is a diagram for explaining image sensor output data including the image data acquired by the video acquiring unit, and an image time signal, stabilization data, and a stabilization time signal generated by the stabilization data generating unit of FIG. 7 according to an exemplary embodiment of the present inventive concept. A configuration of the lens position data generating module 121 including an AF driver 121A and an OIS driver 121B, and an operation of the stabilization data generating unit 120_0 including the lens position data generating module 121 according to an exemplary embodiment of the present inventive concept will be described with reference to FIGS. 7 to 9.

Referring to FIG. 7, the stabilization data generating unit 120_0 according to an exemplary embodiment of the present inventive concept may include the lens position data enerating module 121 including the AF driver 121A and the OIS driver 121B. The lens position data generating module 121 may receive the clock signal Clk, AF data DT_AF, and OIS data DT_OIS. In addition, the lens position data generating module 121 may extract AF data DT_AF′ for the stabilization processing operation of the image data DT_IMG from the AF data DT_AF, and may extract OIS data DT_OIS′ for the stabilization processing operation of the image data DT_IMG from the OIS data DT_OIS. The lens position data generating module 121 may generate the image time signal TS_IMG on the image data DT_IMG, AF time information TS_AF on the AF data DT_AF′, and OIS time information TS_OIS on the OIS data DT_OIS′, on the basis of the clock signal Clk.

According to an exemplary embodiment of the present inventive concept, the AF data DT_AF is data used to perform an AF operation of the lens 400, and may be data on the position of the lens 400 in the incident direction of light. According to an exemplary embodiment of the present inventive concept, the OIS data DT_OIS is data used to perform an OIS operation of the lens 400, and may be data on the position of the lens 400 in the direction substantially perpendicular to the incident direction of light.

The stabilization data generating unit 120_0 may output generated stabilization data group DT_STB1 and the image time signal TS_IMG. The stabilization data group DT_STB1 may include the AF data DT_AF′, the AF time information TS_AF, the OIS data DT_OIS′, and the OIS time information TS_OIS.

Referring to FIG. 8, the stabilization data generating unit 120_0 may extract the AF data DT_AF′ and the OIS data DT_OIS′ in a section in which target pixels included in the pixel array 111 are exposed to obtain the image data DT_IMG. The operation of determining and extracting the AF data DT_AF′ and the OIS data DT_OIS′ may be implemented in a manner similar to the operation of determining and extracting the lens position data DT_LP′ described with reference to FIG. 5.

In other words, the AF data DT_AF acquired in the section from the first time point T11 to the fourth time point T14 (e.g., the first frame Frame0), which is the exposure section of the pixels, may be determined as the AF data DT_AF′, and similarly, the OIS data DT_OIS acquired in the section from the first time point T11 to the fourth time point T14 may be determined as the OIS data DT_OIS′.

Referring to FIG. 9, the image sensor 100 may output image sensor output data DT_ISOUT1 including the stabilization data group DT_STB1, the image data DT_IMG, and the image time signal TS_IMG. According to an exemplary embodiment of the present inventive concept, the synchronizer 160 receives the image data DT_IMG from the buffer 150, receives the stabilization data group DT_STB1 and the image time signal TS_IMG from the stabilization data generating unit 120_0, and may synchronize the received data to output it to the image data processing unit 200. The stabilization data group DT_STB1 may include the AF data DT_AF′, the AF time information TS_AF, the OIS data DT_OIS′, and the OIS time information TS_OIS.

According to an exemplary embodiment of the present inventive concept, the buffer 150 receives the image data DT_IMG from the video acquiring unit 110, and may receive the stabilization data group DT_STB1 and the image time signal TS_IMG from the stabilization data generating unit 120_0. The synchronizer 160 receives the image data DT_IMG, the image time signal TS_IMG, and the stabilization data group DT_STB1 from the buffer 150, and may synchronize the received data to output the image sensor output data DT_ISOUT. The stabilization data group DT_STB1 may include the AF data DT_AF′, the AF time information TS_AF, the OIS data DT_OIS′, and the OIS time information TS_OIS.

According to an exemplary embodiment of the present inventive concept, the image sensor 100 may output the image data DT_IMG, the image time signal TS_IMG, the AF data DT_AF′, the AF time information TS_AF, the OIS data DT_OIS′, and the OIS time information TS_OIS to the image data processing unit 200 through one port.

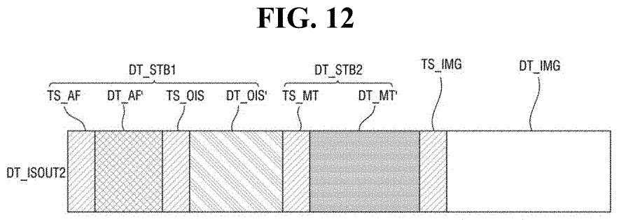

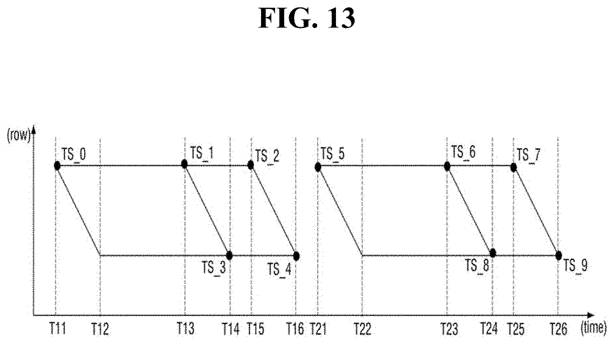

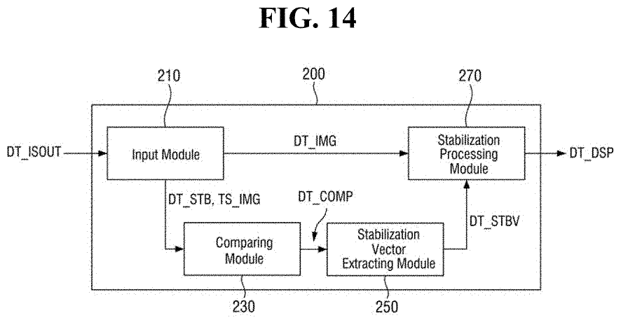

FIG. 10 is a block diagram for explaining a stabilization data generating unit according to an exemplary embodiment of the present inventive concept. FIG. 11 is a diagram for explaining the image data acquired by the video acquiring unit and the stabilization data generated by the stabilization data generating unit of FIG. 10 according to an exemplary embodiment of the present inventive concept. FIG. 12 is a diagram for explaining image sensor output data including the image data acquired by the video acquiring unit, and an image time signal, stabilization data, and a stabilization time signal generated by the stabilization data generating unit of FIG. 10 according to an exemplary embodiment of the present inventive concept. The operation of the stabilization data generating unit 120_1 including the lens position data generating module 121 and a motion data generating module 123 according to an exemplary embodiment of the present inventive concept will be explained with reference to FIGS. 10 to 12. The lens position data generating module 121 will be exemplarily described as including the AF driver 121A and the OIS driver 121B.

Referring to FIG. 10, the stabilization data generating unit 120_1 according to an exemplary embodiment of the present inventive concept may include the lens position data generating module 121 and the motion data generating module 123. In addition, the lens position data generating module 121 may include the AF driver 121A and the OIS driver 121B. The lens position data generating module 121 may receive the clock signal Clk, the AF data DT_AF, and the OIS data DT_OIS. The motion data generating module 123 may receive the clock signal Clk and motion data DT_MT. The stabilization data generating unit 120_1 may generate the image time information TS_IMG on the image data DT_IMG on the basis of the clock signal Clk. For example, the AF driver 121A or the OIS driver 121B of the lens position data generating module 121 may generate the image time information TS_IMG on the basis of the clock signal Clk. As another example, the motion data generating module 123 may generate the image time information TS_IMG on the basis of the clock signal Clk. As still another example, another configuration that generates the image time information TS_IMG on the basis of the clock signal Clk may be further included.

The lens position data generating module 121 may extract the AF data DT_AF′ for the stabilization processing operation of the image data DT_IMG from the AF data DT_AF. In addition, the lens position data generating module 121 may extract OIS data DT_OIS′ for the stabilization processing operation of the image data DT_IMG from the OIS data DT_OIS. The motion data generating module 123 may extract motion data DT_MT′ for the stabilization processing operation of the image data DT_IMG from the motion data DT_MT.

The lens position data generating module 121 may generate the AF time information TS_AF on the AF data DT_AF′ and the OIS time information TS_OIS on the OIS data DT_OIS′ on the basis of the clock signal Clk. The motion data generating module 123 may generate motion time information ST_MT on the motion data DT_MT′ on the basis of the clock signal Clk.

The stabilization data generating unit 120_1 may output the generated stabilization data group DT_STB1, stabilization data group DT_STB2, and the image time signal TS_IMG. The stabilization data group DT_STB1 may include the AF data DT_AF′, the AF time information TS_AF, the OIS data DT_OIS′, and the OIS time information TS_OIS. The stabilization data group DT_STB2 may include the motion data DT_MT′ and the motion time information ST_MT.

Referring to FIG. 11, the stabilization data generating unit 120_1 may extract the AF data DT_AF′, the OIS data DT_OIS′, and the motion data DT_MT′ in a section in which target pixels included in the pixel array 111 are exposed to obtain the image data DT_IMG (e.g., the first frame Frame0). The operation of determining and extracting the AF data DT_AF′ and the OIS data DT_OIS′ may be implemented to correspond to the operation of determining and extracting the AF data DT_AF′ and the OIS data DT_OIS′ described above with reference to FIG. 7. The operation of extracting the motion data DT_MT′ may also be implemented similarly.

In other words, the AF data DT_AF acquired in the section from the first time point T11 to the fourth time point T14, which is the exposure section of the pixel, may be determined as the AF data DT_AF′, the OIS data DT_OIS acquired in the section from the first time point T11 to the fourth time point T14 may be determined as the OIS data DT_OIS′, and similarly, the motion data DT_MT acquired in the section from the first time point T11 to the fourth time point T14 may be determined as the motion data DT_MT′.

Referring to FIG. 12, the image sensor 100 may output image sensor output data DT_ISOUT2 including the stabilization data group DT_STB1, the stabilization data group DT_STB2, the image data DT_IMG, and the image time signal TS_IMG. According to an exemplary embodiment of the present inventive concept, the synchronizer 160 receives the image data DT_IMG from the buffer 150, receives the stabilization data group DT_STB1, the stabilization data group DT_STB2, and the image time signal TS_IMG from the stabilization data generating unit 120_1, and may synchronize the received data to output it to the image data processing unit 200. The stabilization data group DT_STB1 may include the AF data DT_AF′, the AF time information TS_AF, the OIS data DT_OIS′, and the OIS time information TS_OIS, and the stabilization data group DT_STB2 may include the motion data DT_MT′ and the motion time information TS_MT.

According to an exemplary embodiment of the present inventive concept, the buffer 150 may receive the image data DT_IMG from the video acquiring unit 110, and may receive the stabilization data group DT_STB1, the stabilization data group DT_STB2, and the image time signal TS_IMG from the stabilization data generating unit 120_1. The synchronizer 160 may receive the image data DT_IMG, the image time signal TS_IMG, the stabilization data group DT_STB1, and the stabilization data group DT_STB2 from the buffer 150, and may synchronize the received data to output the image sensor output data DT_ISOUT2. The stabilization data group DT_STB1 may include the AF data DT_AF′, the AF time information TS_AF, the OIS data DT_OIS′, and the OIS time information TS_OIS, and the stabilization data group DT_STB2 may include the motion data DT_MT′ and the motion time information TS_MT.

According to an exemplary embodiment of the present inventive concept, the image sensor 100 may output the image data DT_IMG, the image time signal TS_IMG, the AF data DT_AF′, the AF time information TS_AF, the OIS data DT_OIS′, the OIS time information TS_OIS, the motion data DT_MT′, and the motion time information ST_MT to the image data processing unit 200 through one port.

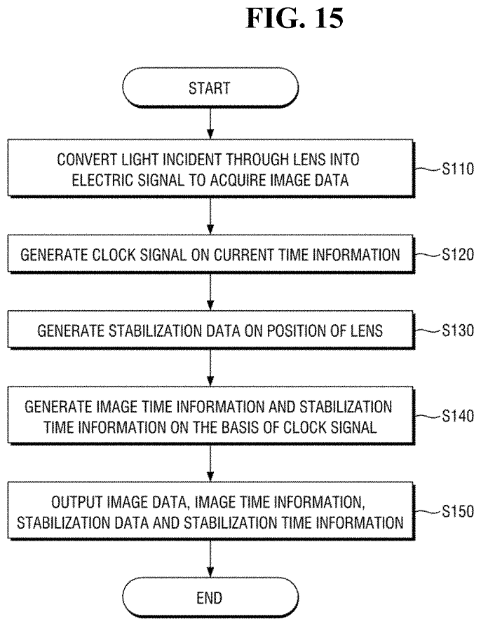

FIG. 13 is a diagram for explaining time information generated in the process of acquiring image data according to an exemplary embodiment of the present inventive concept. As described above, the video acquiring unit 110 of the image sensor 100 according to an exemplary embodiment of the present inventive concept includes the pixel array 111 including the plurality of pixels arranged in a matrix form.

Referring to FIG. 13, a first frame is acquired in a section from a first time point T11 to a sixth time point T16, and a second frame is acquired from a seventh time point T21 to a twelfth time point T26.

First, the process of acquiring the first frame among the image data DT_IMG is as follows.

At the first time point T11, pixels of a first row among the plurality of pixels start to be exposed. In other words, there is a shutter open state. The exposure of the pixels of the first row is performed from the first time point T11 to a third time point T13. In other words, the exposure of the pixels of the first row ends at the third time point T13, and there is a shutter close state. Thereafter, a read operation on the pixels of the first row is performed in the section from the third time point T13 to a fifth time point T15. In other words, the read operation on the pixels of the first row starts at the third time T13, and the read operation on the pixels of the first row ends at the fifth time T15.

Pixels of a last row of the plurality of pixels start to be exposed at a second time point T12, and the exposure of the pixels of the last row is performed from the second time point T12 to a fourth time point T14. Thereafter, the read operation on the pixels of the last row is performed in the section from the fourth time point T14 to the sixth time point T16. In other words, the read operation on the pixels of the last row starts at the fourth time point T14, and the read operation on the pixels of the last row ends at the sixth time point T16.

The operation of the pixels is controlled by a control signal (for example, the clock signal Clk of FIG. 2) to be applied to the video acquiring unit 110. The control signal may be, for example, a shutter control signal or a read signal.

The process of acquiring the second frame from the image data DT_IMG is similar to the process of acquiring the first frame. In other words, the pixels of the first row are exposed in the section between the seventh time point T21 and a ninth time point T23, and the read operation on the pixels of the first row is performed in the section between the ninth time point T23 and an eleventh time point T25. Further, the pixels of the last row are exposed in the section between an eighth time point T22 and a tenth time point T24, and the read operation on the pixels of the last row is performed in the section between the tenth time point T24 and the twelfth time point T26.

According to an exemplary embodiment of the present inventive concept, time information from five time points may be generated in the form of a time stamp.

In the case of the first frame, for example, first time information TS_0 includes information on the first time point T11 at which the exposure of the pixels of the first row starts, second time information TS_1 includes information on the third point T13 at which the exposure of the pixels of the first row ends and the read operation starts, and third time information TS_2 includes information on the fifth time point T15 at which the read operation of the pixels of the first row ends. Fourth time information TS_3 includes information on the fourth time point T14 at which the exposure of pixels of the last row ends and the read operation starts, and fifth time information TS_4 includes information on the sixth time point T16 at which the read operation of the pixels of the last row ends.

Similarly, in the case of the second frame, sixth time information TS_5 including the information on the seventh time point T21 at which the exposure of the pixels of the first row starts, seventh time information TS_6 including information on the ninth time point T23 at which the exposure of the pixels of the first row ends and the read operation starts, and eighth time information TS_7 including information on the eleventh time point T25 at which the read operation on the pixels of the first row ends are generated. Additionally, ninth time information TS_8 including information on the tenth time point T24 at which the exposure of pixels of the last row ends and the read operation starts, and tenth time information TS_9 including information on the twelve time point T26 at which the read operation on the pixels of the last row ends are generated.

According to an exemplary embodiment of the present inventive concept, the time information used for the stabilization processing operation of the image data DT_IMG may include information on an exposure start time point, an exposure end time point (or a read operation start time point), and a read operation end time point of pixels of the first row, and an exposure end time point (or a read operation start time point) and a read operation end time point of pixels of the last row. The exposure start time point of the pixels of the last row may be calculated using the exposure start time point and the exposure end time point of the pixels of the first row, and the exposure end time point of the pixels of the last row. For example, since a difference between the exposure start time point T11 of the pixels of the first row of the first frame and the exposure start time point T12 of the pixels of the last row is the same as a difference between the exposure end time point T13 of the pixels of the first row and the exposure end time point T14 of the pixels of the last row, the exposure start time point T12 of the pixels of the last row may be calculated according to Formula 1 below.

T12=T11+(T14−T13) [Formula 1]

As a result, by reducing the amount of time information required for the stabilization processing operation of the image data DT_IMG, the workload of the image processing system 10 can be minimized.

The time information described above may be generated for the image data DT_IMG and the stabilization data (e.g., DT_LP of FIG. 5, DT_AF and DT_OIS of FIG. 8, and DT_MT of FIG. 11).

FIG. 14 is a block diagram for explaining an image data processing unit according to an exemplary embodiment of the present inventive concept.

Referring to FIG. 14, the image data processing unit 200 according to an exemplary embodiment of the present inventive concept may include an input module 210, a comparing module 230, a stabilization vector extracting module 250, and a stabilization processing module 270.

The input module 210 may receive the input of the image sensor output data DT_ISOUT that is output from the image sensor 100. The image sensor output data DT_ISOUT may include the image data DT_IMG, the image time information TS_IMG, and the stabilization data group DT_STB, and the stabilization data group DT_STB may include stabilization data (e.g., DT_LP′ of FIG. 6) and stabilization time information (e.g., TS_LP of FIG. 6). The input module 210 may output the image data DT_IMG from the image sensor output data DT_ISOUT to the stabilization processing module 270, and may output the stabilization data group DT_STB and the image time information TS_IMG to the comparing module 230. According to an exemplary embodiment of the present inventive concept, the input module 210 may extract the stabilization data group DT_STB and the image data DT_IMG from the input data, using the contents of the header of the image sensor output data DT_ISOUT. According to an exemplary embodiment of the present inventive concept, the stabilization data group DT_STB may include only some of the lens position information or motion information received by the image sensor 100.

The comparing module 230 may compare the received stabilization data group DT_STB and the image time information TS_IMG to output comparison output data DT_COMP. For example, when the stabilization data group DT_STB includes the lens position data DT_LP′ and the lens position time information TS_LP, the image time information TS_IMG and the lens position time information TS_LP may be compared and output. As another example, when the stabilization data group DT_STB includes the motion data DT_MT′ and the motion time information TS_MT, the image time information TS_IMG and the motion time information TS_MT may be compared and output.

The stabilization vector extracting module 250 may generate and output stabilization vector data DT_STBV, using the comparison output data DT_COMP of the comparing module 230. For example, when the stabilization data group DT_STB includes the lens position data DT_LP′ and the lens position time information TS_LP, since an auto focusing (AF) processing or optical image stabilization (OIS) processing operation is already performed in the acquisition process of the image data DT_IMG, it is possible to generate the stabilization vector data DT_STBV in consideration of this. As a result, it is possible to prevent an artifact that occurs due to the duplicated execution of the OIS processing operation and the EIS processing operation even though the AF processing or the OIS processing operation has already been executed.

As another example, when the stabilization data group DT_STB includes the motion data DT_MT′ and the motion time information TS_MT, the stabilization vector data DT_STBV may be generated and output in consideration of information on the motion of the object 20.

After this, the stabilization processing module 270 may perform the stabilization processing operation of the image data DT_IMG to output corrected data DT_DSP, on the basis of the image data DT_IMG received from the input module 210 and the stabilization vector data DT_STBV received from the stabilization vector extracting module 250. In other words, it is possible to correct the image data DT_IMG and output the corrected data DT_DSP to the display unit 300.

According to an exemplary embodiment of the present inventive concept, the comparing module 230, the stabilization vector extracting module 250, and the stabilization processing module 270 may be implemented in software. In other words, the image data processing unit 200 may be implemented in one application processor AP, and the application processor may function as the comparing module 230, the stabilization vector extracting module 250, and the stabilization processing module 270 via software. Alternatively, elements of the image data processing unit 200 may be implemented in hardware, e.g., as circuits.

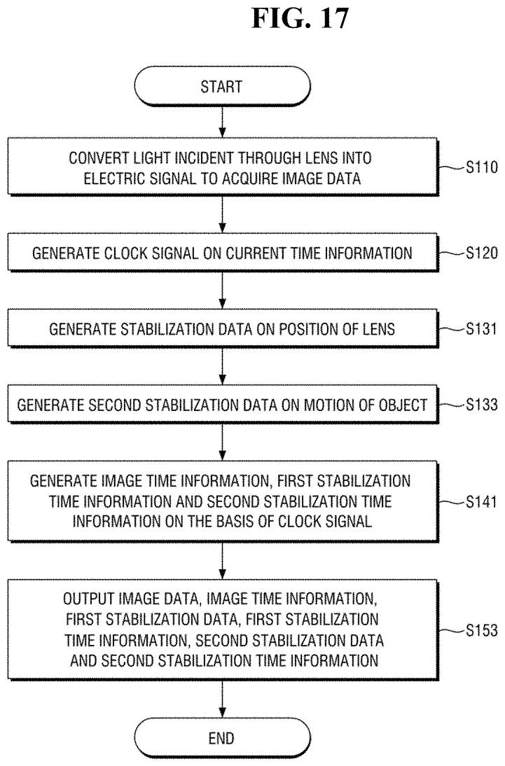

FIGS. 15 to 17 are flowcharts for explaining an operation of an image sensor according to exemplary embodiments of the present inventive concept. For convenience of explanation, in describing FIGS. 15 and 16, it is assumed that the stabilization data generating unit 120 includes the lens position data generating module 121 of FIG. 4, and thus, the lens position data DT_LP′ and the lens position time information TS_LP of FIG. 6 are output as stabilization data and stabilization time information, respectively.

Referring to FIG. 15, in operation S110, the video acquiring unit 110 may convert light incident through the lens 400 into an electrical signal to acquire the image data DT_IMG.

In operation S120, the clock signal generating unit 130 may generate the clock signal Clk on the current time information and may output the clock signal Clk to the video acquiring unit 110 and the stabilization data generating unit 120.

In operation S130, the stabilization data generating unit 120 may generate the lens position data DT_LP′ on the position of the lens 400. According to an exemplary embodiment of the present inventive concept, the lens position data DT_LP′ may include information on the position of the lens 400 in the incident direction of light, and may include result information from performing the AF operation of the lens 400. According to an exemplary embodiment of the present inventive concept, the lens position data DT_LP′ may include information on the position of the lens 400 in the direction perpendicular to the incident direction of light, and may include result information from performing the OIS operation of the lens 400.

In operation S140, the stabilization data generating unit 120 may generate the image time information TS_IMG and the lens position time information TS_LP on the basis of the clock signal Clk received from the clock signal generating unit 130. According to an exemplary embodiment of the present inventive concept, when the lens position data DT_LP′ includes result information from the AF operation of the lens 400, the lens position time information TS_LP may be the AF time information TS_AF on the AF data DT_AF. According to an exemplary embodiment of the present inventive concept, when the lens position data DT_LP′ includes the result information from the OIS operation of the lens 400, the lens position time information TS_LP may be the OIS time information TS_OIS on the OIS data DT_OIS.

In operation S150, the image sensor 100 may output the image data DT_IMG, the image time information TS_IMG, and the stabilization data group DT_STB. The stabilization data group DT_STB may include the lens position data DT_LP′ and the lens position time information TS_LP. According to an exemplary embodiment of the present inventive concept, the buffer 150 receives the image data DT_IMG from the video acquiring unit 110 and outputs it to the synchronizer 160, the stabilization data generating unit 120 outputs the image time information TS_IMG and the stabilization data group DT_STB to the synchronizer 160, and the synchronizer 160 may synchronize the received image data, the image time information TS_IMG, and the stabilization data group DT_STB to output them to the image data processing unit 200.

According to an exemplary embodiment of the present inventive concept, the buffer 150 may receive the image data DT_IMG from the video acquiring unit 110, and may receive the image time signal TS_IMG and the stabilization data group DT_STB from the stabilization data generating unit 120. Thereafter, the buffer 150 may output the received image data DT_IMG, the image time signal TS_IMG, and the stabilization data group DT_STB to the synchronizer 160, and the synchronizer 160 may synchronize the received data to output it to the image data processing unit 200.

Referring to FIG. 16, the image sensor output data DT_ISOUT may be output through one port. Operations S110 to S140 may be performed in substantially the same manner as FIG. 15 described above.

In operation S151, the image sensor 100 may output the image data DT_IMG, the image time information TS_IMG, and the stabilization data group DT_STB, using one port. According to an exemplary embodiment of the present inventive concept, the stabilization data group may include the lens position time information TS_LP on the lens position data DT_LP′ and the lens position data DT_LP′.

According to an exemplary embodiment of the present inventive concept, the port to be output may be a mobile industry processor interface (MIPI) port. In other words, the image sensor output data DT_IS OUT may be output from the image sensor 100 to the image data processing unit 200 through MIPI. In this case, the image data DT_IMG, the image time information TS_IMG, and the stabilization data group DT_STB included in the image sensor output data DT_IS OUT may be output in an embedded data format or a general data format of MIPI.

Referring to FIG. 17, the image sensor 100 may further generate and output the motion data DT_MT on the motion of the object 20. Operations of S110 and S120 may be performed in substantially the same manner as FIG. 15 described above.

The stabilization data generating unit 120 may generate stabilization data on the position of lens (e.g., the lens position data DT_LP′) in operation S131, and may generate second stabilization data on the motion of the object 20 (e.g., the motion data DT_MT′) in operation S133.

In operation S141, the stabilization data generating unit 120 may generate and output the image time information TS_IMG, first stabilization time information (e.g., the lens position time information TS_LP) and second stabilization time information (e.g., the motion time information TS_MT) on the basis of the clock signal Clk.

In operation S153, the image sensor may output the image data DT_IMG, the image time information TS_IMG, a first stabilization data group, and a second stabilization data group. The first stabilization data group includes the first stabilization data and the first stabilization time information. Additionally, the second stabilization data group includes the second stabilization data and the second stabilization time information.

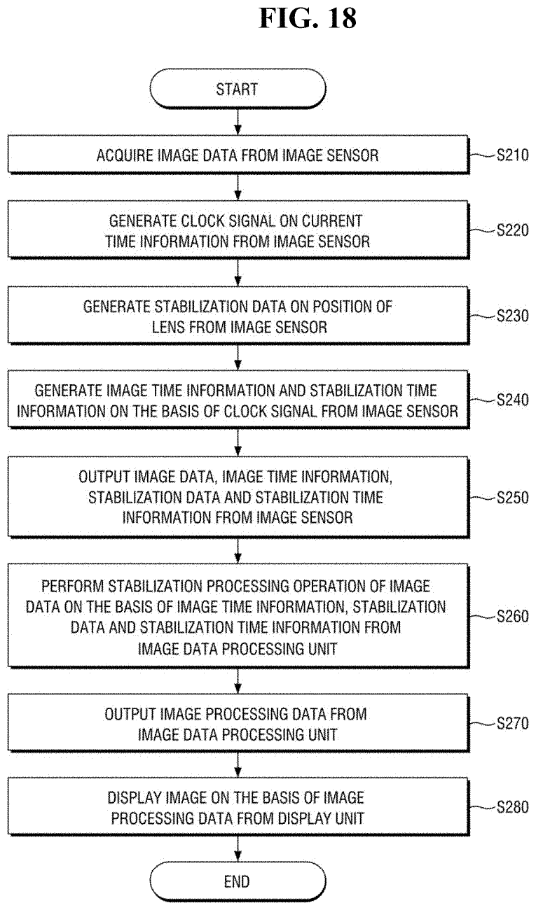

FIG. 18 is a flowchart for explaining an operation of an image processing system according to an exemplary embodiment of the present inventive concept. Substantially the same processes as those of operations S110 to S150 of FIG. 15 may be performed in operations S210 to S250.

In operation S260, the image data processing unit 200 may receive the image sensor output data DT_IS OUT from the image sensor 100, and may perform the stabilization processing operation of the image data DT_IMG on the basis thereof. The image sensor output data DT_IS OUT includes the image data DT_IMG, the image time information TS_IMG, and the stabilization data group DT_STB, and at this time, the stabilization data group DT_STB may include stabilization data and stabilization time information.

The process described with reference to FIG. 14 may be performed in the stabilization processing operation. In other words, on the basis of the image sensor output data DT_ISOUT received from the input module 210, the stabilization processing operation of the image data DT_IMG is performed in the comparing module 230, the stabilization vector extracting module 250, and the stabilization processing module 270, and as a result, image processing data (e.g., the corrected data DT_DSP of FIG. 14) may be generated.

In operation S270, the image data processing unit 200 outputs image processing data subjected to fabrication, such as the stabilization processing of the image data DT_IMG.

In operation S280, the display unit 300 receives the image processing data and displays an image on the basis of the image processing data.

While the present inventive concept has been shown and described with reference to exemplary embodiments thereof, it will be apparent to those of ordinary skill in the art that various modifications in form and details may be made thereto without departing from the spirit and scope of the present inventive concept as set forth by the appended claims.

What is claimed is:

1. An image sensor comprising:
a video acquiring circuit configured to convert light incident in a first direction through a lens into an electrical signal to acquire image data;
a clock signal generating circuit configured to generate and output a clock signal on current time information;
a stabilization data generating circuit configured to generate stabilization data for processing the image data, image time information on a time point at which the image data is acquired, and stabilization time information on a time point at which the stabilization data is generated, on the basis of the clock signal; and
an output circuit configured to output data received from the video acquiring circuit and the stabilization data generating circuit,
wherein the stabilization data generating circuit generates first stabilization data on a position of the lens and first stabilization time information on a time point at which the first stabilization data is generated, and
the output circuit outputs the image data, the image time information, the first stabilization data, and the first stabilization time information.

2. The image sensor of claim 1, wherein the first stabilization data includes auto focusing (AF) data on a position of the lens in the first direction, and optical image stabilization (OIS) data on a positions of the lens in a second direction and a third direction, wherein the second direction is perpendicular to the first direction, and the third direction is perpendicular to the first and second directions, and
the output circuit outputs the image data, the image time information, the AF data, AF time information on a time at which the AF data is generated, the OIS data, and OIS time information on a time at which the OIS data is generated.

3. The image sensor of claim 1, wherein the stabilization data generating circuit further generates second stabilization data on a motion of an object and second stabilization time information on a time at which the second stabilization data is generated, and the output circuit further outputs the second stabilization data and the second stabilization time information.

4. The image sensor of claim 3, wherein the first stabilization data includes AF data on a position of the lens in the first direction and OIS data on positions of the lens in a second direction and a third direction, wherein the second direction is perpendicular to the first direction, and the third direction is perpendicular to the first and second directions, and
the output circuit outputs the image data, the image time information, the AF data, AF time information on a time at which the AF data is generated, the OIS data, OIS time information on a time at which the OIS data is generated, the second stabilization data, and the second stabilization time information.

5. The image sensor of claim 1, further comprising:
a synchronizer circuit configured to receive the image data from the video acquiring circuit, receive the image time information, the first stabilization data, and the first stabilization time information from the stabilization data generating circuit, and generate synchronous data on the basis of the image data, the image time information, the first stabilization data, and the first stabilization time information,
wherein the output circuit outputs the synchronous data generated from the synchronizer circuit.

6. The image sensor of claim 1, wherein the output circuit outputs the image data, the image time information, the first stabilization data, and the first stabilization time information through one port.

7. The image sensor of claim 1, wherein the first stabilization data includes position information of the lens at an exposure section of a pixel for acquiring the image data.

8. The image sensor of claim 1, wherein the video acquiring circuit includes a pixel array in which a plurality of pixels are arranged in a matrix form, and
the stabilization data generating circuit generates the image time information and the first stabilization time information on at least one time point of (1) an exposure start time point of pixels of a first row among the plurality of pixels for acquisition of the image data, (2) a read operation start time point of the pixels of the first row, (3) a read operation end time point of the pixels of the first row, (4) a read operation start time point of pixels of a last row among the plurality of the pixels for acquisition of the image data, and (5) a read operation end time point of the pixels of the last row.

9. An image sensor comprising:
a video acquiring circuit including a plurality of pixels arranged in a matrix form, and configured to acquire image data obtained by converting light incident through a lens into an electrical signal using a target pixel group of at least some of the plurality of pixels, wherein the video acquiring circuit exposes pixels of a first row of the target pixel group in a first section, performs a read operation of the pixels of the first row in a second section, exposes pixels of a last row of the target pixel group in a third section, and performs a read operation on the pixels of the last row in a fourth section;
a clock signal generating circuit configured to generate and output a clock signal on current time information;
a stabilization data generating circuit configured to generate first stabilization data on positions of the lens in the first and third sections, and generate image time information on a time at which the image data is acquired and first stabilization time information on a time at which the first stabilization data is generated, on the basis of the clock signal; and
an output circuit configured to output data received from the video acquiring circuit and the stabilization data generating circuit.

10. The image sensor of claim 9, wherein the stabilization data generating circuit generates the image time information and the first stabilization time information on at least one time point of a start time point of the first section, a start time point of the second section, an end time point of the second section, a start time point of the fourth section, and an end time point of the fourth section.

11. The image sensor of claim 9, wherein the first stabilization data includes AF data on a position of the lens in an incident direction of light in the first and third sections, and OIS data on a position of the lens in a direction substantially perpendicular to the incident direction of light in the first and third sections, and
the output circuit outputs the image data, the image time information, the AF data, AF time information on a time at which the AF data is generated, the OIS data, and OIS time information on a time at which the OIS data is generated.

12. The image sensor of claim 9, wherein the stabilization data generating circuit further generates a second stabilization data on a motion of an object in the first and third sections, and second stabilization time information on a time at which the second stabilization data is generated, and
the output circuit further outputs the second stabilization data and the second stabilization time information.

13. The image sensor of claim 12, wherein the first stabilization data includes AF data on a position of the lens in the incident direction of light in the first and third sections, and OIS data on a position of the lens in a direction substantially perpendicular to the incident direction of light in the first and third sections, and
the output circuit outputs the image data, the image time information, the AF data, AF time information on a time at which the AF data is generated, the OIS data, OIS time information on a time at which the OIS data is generated, the second stabilization data, and the second stabilization time information.

14. An image processing system comprising:
an image sensor configured to generate image data acquired by converting light incident through a lens into an electrical signal, image time information on a time at which the image data is acquired, stabilization data on a position of the lens, and stabilization time information on a time at which the stabilization data is generated;
an image data processing circuit configured to perform an electronic image stabilization (EIS) processing operation on the basis of the image data, the image time information, the stabilization data, and the stabilization time information, and output image processing data generated on the basis of the EIS processing operation; and
a display circuit configured to receive the image processing data and display an image on the basis of the image processing data.

15. The image processing system of claim 14, wherein the image sensor includes a pixel array having a plurality of pixels arranged in a matrix form, and generates the image time information and the stabilization time information on at least one of a first time point, a second time point, a third time point, a fourth time point, and a fifth time point,
the first time point is an exposure start time point of pixels of a first row among the plurality of pixels for acquisition of the image data,
the second time point is a read operation start time point of the pixels of the first row,
the third time point is a read operation end time point of the pixels of the first row,
the fourth time point is a read operation start time point of pixels of a last row among the plurality of pixels for acquisition of the image data, and
the fifth time point is a read operation end time point of the pixels of the last row.

16. The image processing system of claim 15, wherein the image data processing circuit calculates a time point at which a time, corresponding to a difference between the second time point and the fourth time point, has passed from the first time point to determine an exposure start time of the pixels of the last row, and
the image data processing circuit performs the EIS processing operation on the basis of the image time information, the stabilization time information, and the exposure start time point of the pixels of the last row.

17. The image processing system of claim 14, wherein the image sensor outputs the image data, the image time information, the stabilization data, and the stabilization time information to the image data processing circuit through one port.

18. The image processing system of claim 14, wherein the image sensor further generates motion data on a motion of an object and motion time information on a time at which the motion data is generated, and
the image data processing circuit performs the EIS processing operation on the basis of at least one of the image data, the image time information, the stabilization data, the stabilization time information, the motion data, and the motion time information.

19. The image processing system of claim 14, wherein the stabilization data includes position information of the lens in an incident direction of light, and position information of the lens in a direction substantially perpendicular to the incident direction of light.

20. The image processing system of claim 14, wherein the image data processing circuit comprises:
a stabilization vector generating circuit configured to generate stabilization vector data on the basis of the image time information, the stabilization data, and the stabilization time information; and
a stabilization circuit configured to perform the EIS processing operation on the basis of the image data and the stabilization vector data, and generate the image processing data.
